(19) United States
(12) Patent Application Publication
(10) Pub. No.: US 2026/0288236 A1
(43) Pub. Date: Sep. 24, 2026

(54) CONTROL APPARATUS, CONTROL METHOD FOR CONTROL APPARATUS, AND STORAGE MEDIUM THAT ENABLE PERSON WHO IS HAVING FACE-TO-FACE CONVERSATION WITH HMD WEARER TO NATURALLY FEEL SIGHT LINE OF THE HMD WEARER

(71) Applicant: CANON KABUSHIKI KAISHA, Tokyo (JP)

(72) Inventors: KOJI KAWASHIMA, Tokyo (JP); RYOSUKE SHODA, Tokyo (JP)

(21) Appl. No.: 19/569,317

(22) Filed: Mar. 17, 2026

(30) Foreign Application Priority Data
Mar. 18, 2025 (JP) 2025-043627

(51) Int. Cl. G06F 3/01; G06T 13/00; G06V 40/10

(52) U.S. Cl. CPC G06F 3/013; G06T 13/00; G06V 40/10

(57) ABSTRACT

A control apparatus for controlling a display of an HMD includes one or more processors and memory configured to execute a processing that, based on an image obtained by a first photographing unit to photograph a sight line direction of a wearer of the HMD, detects a person around the wearer, execute a processing that, based on an image obtained by a second photographing unit to photograph the wearer side, detects a direction of a sight line of the wearer, and execute a control processing that causes an outer display of the HMD to display an image of eyes of the wearer, which has been obtained by the second photographing unit. When the sight line of the wearer is facing a CG content displayed on an inner display of the HMD, the outer display is caused to display an image imitating eyes looking in a direction of the person detected.

### BACKGROUND

### FIELD OF THE TECHNOLOGY

The present disclosure relates to a control apparatus, a control method for the control apparatus, and a storage medium.

### DESCRIPTION OF THE RELATED ART

In recent years, technologies such as virtual reality (VR), which allows you to experience a computer-generated virtual space as if it were real, and mixed reality (MR), which combines the real world and a virtual world to project virtual objects as if they were right in front of you, have become widespread.

MR technology is used in a variety of situations, and for example, wearing a head mounted display (an HMD) in the office, displaying the surrounding situation via pass-through while freely positioning application windows, etc. As a result, it is possible to do desk work while keeping an eye on what's going on in the office. Furthermore, when meeting with colleagues or serving customers, the person giving the explanation can wear an HMD and use MR to view video materials while talking, allowing for effective information transmission without the need to look down at the materials at hand. On the other hand, in such a conversation between a person wearing an HMD (an HMD wearer) and a person not wearing an HMD (a non-wearer), since the eyes of the HMD wearer are hidden by the HMD, eye contact or the like is not possible, which can hinder smooth communication. Therefore, a method for presenting information about a line of sight (a sight line) of the HMD wearer on an outer display of the HMD is being considered. As a related technique, for example, the technique disclosed in PCT International Publication No. WO2017/199483 has been proposed. In the technique disclosed in PCT International Publication No. WO2017/199483, an image, which has been processed so that a sight line of a communication partner shown on a display is facing a user who is looking at the display, is displayed on the display.

However, in the technique disclosed in PCT International Publication No. WO2017/199483 that has been described above, it does not assume that an HMD is used as a device for displaying the image. Therefore, in the case where the HMD wearer is talking with a person around him/her while referring to a CG content (application windows, 3D CG models, etc.) displayed on an inner display of the HMD, him/her sight line will move back and forth between the CG content and the person he/she is talking with, and the eyes displayed on the outer display of the HMD will also move back and forth accordingly. Such a display may result in unnatural eye movements, such as the HMD wearer is looking around, which may hinder communication.

### SUMMARY

The present disclosure provides a mechanism that enables a person who is having a face-to-face conversation with an HMD wearer to naturally feel a sight line of the HMD wearer.

Accordingly, an aspect of the present disclosure provides a control apparatus for controlling a display of a head mounted display device, the control apparatus comprising one or more processors and memory configured to execute a first detection processing that, based on an image obtained by a first photographing unit provided in the head mounted display device to be oriented to photograph a sight line direction of a wearer of the head mounted display device, detects a person around the wearer, execute a second detection processing that, based on an image obtained by a second photographing unit provided in the head mounted display device to be oriented to photograph the wearer side, detects a direction of a sight line of the wearer, and execute a control processing that causes an outer display of the head mounted display device to display an image of eyes of the wearer, which has been obtained by the second photographing unit. In the control processing, in a case where the sight line of the wearer is facing a CG content displayed on an inner display of the head mounted display device, the outer display is caused to display an image imitating eyes looking in a direction of the person detected by the first detection processing.

Features of the present disclosure will become apparent from the following description of embodiments with reference to the attached drawings. The following description of embodiments is described by way of example.

### BRIEF DESCRIPTION OF THE DRAWINGS

FIG. 1A, FIG. 1B, and FIG. 1C are diagrams that illustrate a configuration of a control apparatus according to one or more aspects of the present disclosure.

FIG. 2A, FIG. 2B, FIG. 2C, FIG. 2D, FIG. 2E, and FIG. 2F are diagrams for explaining a situation in which smooth communication in a conversation between a wearer of a conventional control apparatus and a non-wearer is hindered.

FIG. 3 is a flowchart that illustrates a procedure of a display control processing executed by the control apparatus shown in FIG. 1A, FIG. 1B, and FIG. 1C.

FIG. 4A, FIG. 4B, FIG. 4C, FIG. 4D, FIG. 4E, and FIG. 4F are diagrams for explaining images displayed on an external display, which is shown in FIG. 1A and FIG. 1C, by the display control processing shown in FIG. 3.

FIG. 5 is diagram that illustrates an example of a message displayed on the external display, which is shown in FIG. 1A and FIG. 1C.

FIG. 6 is a flowchart that illustrates another procedure of the display control processing executed by the control apparatus shown in FIG. 1A, FIG. 1B, and FIG. 1C.

### DESCRIPTION OF THE EMBODIMENTS

The present disclosure will now be described in detail below with reference to the accompanying drawings showing embodiments thereof.

Hereinafter, an embodiment of the present disclosure will be described in detail with reference to the drawings.

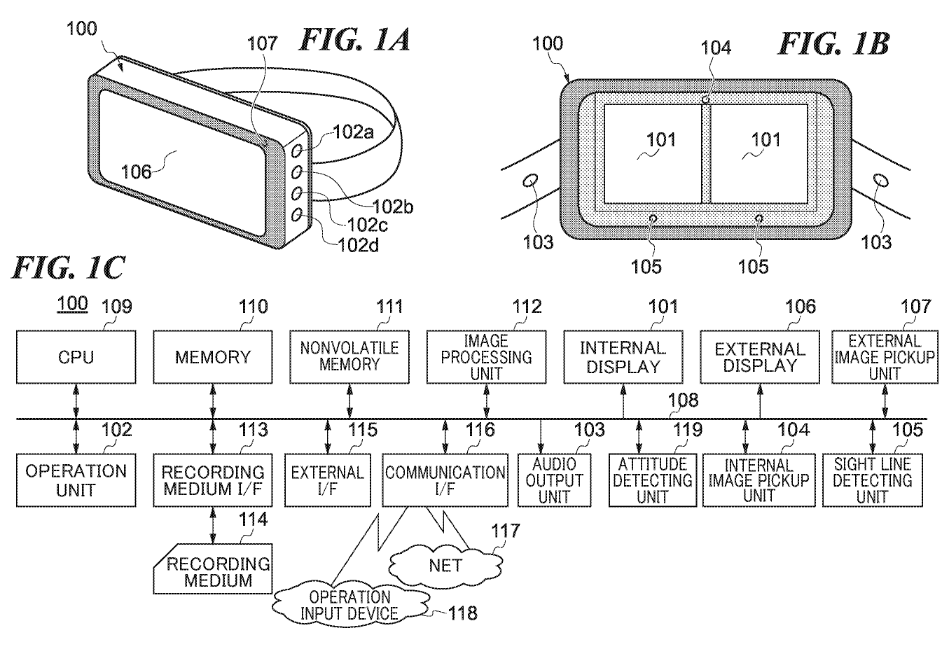

FIG. 1A, FIG. 1B, and FIG. 1C are diagrams that illustrate a configuration of a control apparatus 100 according to the embodiment of the present disclosure. FIG. 1A is an external appearance view of the control apparatus 100 as viewed from the front side. FIG. 1B is an external appearance view of the control apparatus 100 as viewed from the rear side (a wearer side). FIG. 1C is a block diagram that schematically illustrates the configuration of the control apparatus 100.

The control apparatus 100 is, for example, a head mounted display device using an optical see-through method or a video see-through method, such as an HMD. As shown in FIG. 1A and FIG. 1B, the control apparatus 100 includes an internal display 101, operation members 102a to 102d, an audio output unit 103, an internal image pickup unit 104 (a second photographing unit serving as a second photographing means), a sight line detecting unit 105, an external display 106, and an external image pickup unit 107 (a first photographing unit serving as a first photographing means).

The internal display 101 is a display provided on an inner side surface of the control apparatus 100 (on the wearer side of the control apparatus 100). The internal display 101 displays VR images, MR images, and various types of information. The operation member 102a is a power button for switching a power supply of the control apparatus 100 on and off. The operation member 102b and the operation member 102c are volume buttons for increasing and decreasing a volume of audio output from the audio output unit 103, respectively. The operation member 102d is a home button for causing the internal display 101 to display a home screen. It should be noted that in FIG. 1C, the operation members 102a to 102d are collectively referred to as an operation unit 102. The audio output unit 103 is a speaker that produces audio. The internal image pickup unit 104 is a camera provided in the control apparatus 100 to be oriented to photograph the wearer side, and the internal image pickup unit 104 obtains (captures) an image of the wearer. The sight line detecting unit 105 detects a direction of a sight line of the wearer based on the image of the wearer obtained (captured) by the internal image pickup unit 104. For example, the sight line detecting unit 105 detects which CG content the wearer is looking at among CG contents displayed on the internal display 101.

The external display 106 is a display provided on an outer side surface of the control apparatus 100. In order to maintain a connection between the wearer and the real world around him/her, the external display 106 is capable of displaying eyes of the wearer and a response state of the wearer. The external image pickup unit 107 is a camera provided in the control apparatus 100 to be oriented to photograph a sight line direction of the wearer, and the external image pickup unit 107 obtains (captures) an image of the environment and people around the wearer.

In addition to the components shown in FIG. 1A and FIG. 1B that have been described above, as shown in FIG. 1C, the control apparatus 100 also includes a CPU 109, a memory 110, a nonvolatile memory 111, an image processing unit 112, a recording medium I/F 113, a recording medium 114, an external I/F 115, a communication I/F 116, and an attitude detecting unit 119.

A bus 108 shown in FIG. 1C is a transmission path, and the respective units connected to the bus 108 are capable of exchanging data with each other via the bus 108. The CPU 109, the memory 110, the nonvolatile memory 111, the image processing unit 112, the internal display 101, the operation unit 102, the recording medium I/F 113, the external I/F 115, the communication I/F 116, the audio output unit 103, the attitude detecting unit 119, the internal image pickup unit 104, the sight line detecting unit 105, the external display 106, and the external image pickup unit 107 are connected to the bus 108.

The CPU 109 controls the entire control apparatus 100, and is configured by at least one or more processors or circuits. The memory 110 is configured by, for example, a RAM (a volatile memory using a semiconductor element, or the like). The nonvolatile memory 111 is configured by, for example, a flash memory, a ROM, or the like. The CPU 109 controls each unit (each component) of the control apparatus 100 in accordance with a program stored in, for example, the nonvolatile memory 111, by using the memory 110 as a working memory. The nonvolatile memory 111 stores image data, audio data, other data, various kinds of programs for the CPU 109 to operate, etc.

Based on the control of the CPU 109, the image processing unit 112 performs various types of image processing with respect to an image stored in the nonvolatile memory 111 or the recording medium 114, image signals obtained via the external I/F 115, an image obtained via the communication I/F 116, an image obtained via the internal image pickup unit 104, an image obtained via the external image pickup unit 107, or the like. The image processing performed by the image processing unit 112 includes an A/D conversion processing and a D/A conversion processing, and also includes an encoding processing, a compression processing, a decoding processing, an enlargement/reduction processing (a resizing processing), a noise reduction processing, a color conversion processing, an object detection processing, a person position detection processing, etc., which are to be performed with respect to the image data. The image processing unit 112 may be configured with a dedicated circuit block for performing a specific image processing. In addition, depending on the type of the image processing, it is also possible for the CPU 109 to perform the image processing in accordance with a program without using the image processing unit 112.

Based on the control of the CPU 109, the internal display 101 and the external display 106 each display images, a GUI screen that constitutes a graphical user interface (a GUI), etc. The CPU 109 generates display control signals and image signals in accordance with a program, and controls the respective units (the respective component) of the control apparatus 100 so as to output them to the internal display 101 and the external display 106. The internal display 101 and the external display 106 each display an image based on the image signals output from the CPU 109.

The recording medium I/F 113 is configured to allow the recording medium 114 such as a memory card, a compact disc (a CD), or a digital versatile disc (a DVD) to be attached, and performs reading out data from and writing in data to the recording medium 114 based on the control of the CPU 109. The external I/F 115 is an interface for connecting to an external device via a wired cable or wirelessly, and for inputting and outputting image signals and audio signals.

The communication I/F 116 is an interface for communicating with an external device, the Internet 117, or the like, and for transmitting and receiving various kinds of data such as files and commands. The CPU 109 is an interface that uses the communication I/F 116 to communicate with an operation input device 118 to receive operation input information from the operation input device 118 and to transmit and receive data to and from another HMD operated by another wearer. The audio output unit 103 outputs audio of video and music data, operation sounds, ringtones, various kinds of notification sounds, and the like.

The attitude detecting unit 119 detects an attitude of the control apparatus 100 relative to the direction of gravity and a tilt of the attitude relative to each of the roll, pitch, and yaw axes. Based on the attitude of the control apparatus 100 that has been detected by the attitude detecting unit 119, it is possible to determine whether the control apparatus 100 is being held horizontally, vertically, facing upward, facing downward, or at an angle. As the attitude detecting unit 119, it is possible to use at least one of an acceleration sensor, a gyro sensor, a geomagnetic sensor, a direction sensor, an altitude sensor, and the like, and it is also possible to use a combination of two or more of the acceleration sensor, the gyro sensor, the geomagnetic sensor, the direction sensor, the altitude sensor, and the like. When the wearer moves his/her head or body, the attitude of the control apparatus 100 also changes. Detecting the attitude of the control apparatus 100 by the attitude detecting unit 119 is synonymous with detecting an attitude of the head of the wearer. The attitude detecting unit 119 detects a change in the attitude of the control apparatus 100, and based on the detected change in in the attitude of the control apparatus 100, the CPU 109 performs a VR display processing or an MR display processing.

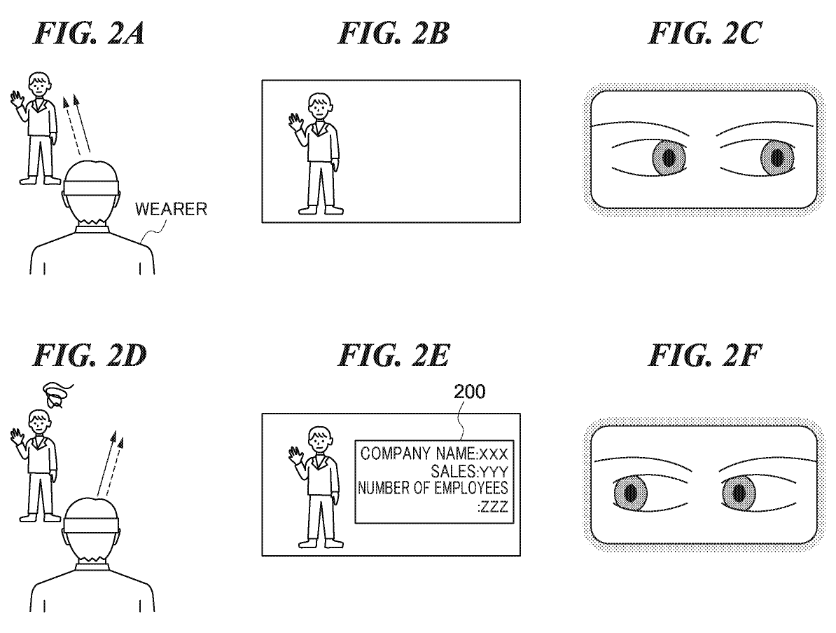

Next, with reference to FIG. 2A, FIG. 2B, FIG. 2C, FIG. 2D, FIG. 2E, and FIG. 2F, a situation will be described in which smooth communication in a conversation between a wearer of a conventional HMD (a conventional HMD wearer) and a non-wearer is hindered. FIG. 2A is a diagram that illustrates a situation in which the conventional HMD wearer (on this side) is having a conversation with the non-wearer (on the back side). In FIG. 2A, a dotted-line arrow indicates a sight line direction of the conventional HMD wearer, and a solid-line arrow indicates a sight line direction of eyes displayed on an external display of the conventional HMD, both of which are facing a direction of the conversation partner (the non-wearer). FIG. 2B is a diagram that illustrates an example of the display content of an internal display of the conventional HMD in the situation shown in FIG. 2A. On the internal display of the conventional HMD, a surrounding image obtained (captured) by an external image pickup unit of the conventional HMD is displayed in pass-through, and this surrounding image includes the conversation partner of the conventional HMD wearer. FIG. 2C is a diagram that illustrates an example of the display content of the external display of the conventional HMD in the situation shown in FIG. 2A. On the external display of the conventional HMD, an image of eyes of the conventional HMD wearer, which has been obtained (captured) by an internal image pickup unit of the conventional HMD, is displayed in real time. The display on the external display of the conventional HMD allows the conversation partner of the conventional HMD wearer to know the sight line of the conventional HMD wearer, and enables smooth communication with the conventional HMD wearer.

Here, in the case where the conventional HMD wearer is conversing while looking at a CG content 200 (explanatory materials) of FIG. 2E displayed on the internal display of the conventional HMD, the sight line of the conventional HMD wearer will be in a direction indicated by a dotted line shown in FIG. 2D. In such a case, if the eyes looking at the CG content 200 side are displayed on the external display of the conventional HMD as shown in FIG. 2F, as indicated by a solid line shown in FIG. 2D, a sight line direction of the image of the eyes of the conventional HMD wearer displayed on the external display of the conventional HMD will become different from the direction of the conversation partner of the conventional HMD wearer. The conversation partner of the conventional HMD wearer may feel that the conventional HMD wearer is looking away, which causes an issue of inconvenience (unsuitable) in communication.

In order to address the above issue, in the embodiment of the present disclosure, in the case where the sight line of the wearer of the control apparatus 100 is facing the CG content displayed on the internal display 101, the external display 106 is caused to display an image that imitates eyes looking in a direction of a conversation partner of the wearer of the control apparatus 100.

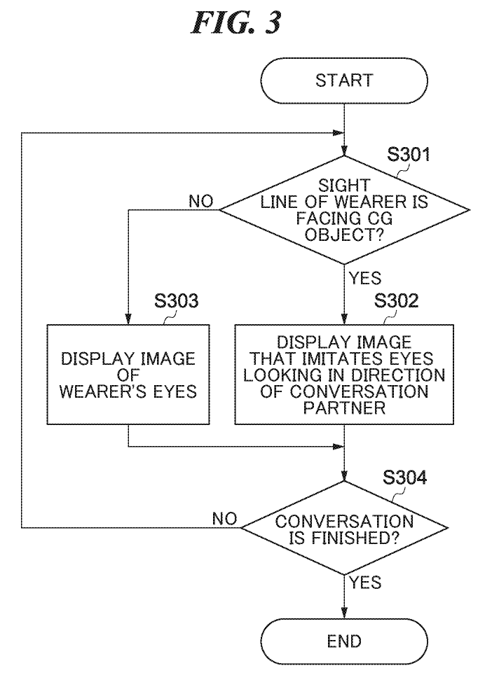

FIG. 3 is a flowchart that illustrates a procedure of a display control processing executed by the control apparatus 100 shown in FIG. 1A, FIG. 1B, and FIG. 1C. Here, as an example, a case will be described in which the wearer of the control apparatus 100 is having a conversation with a person facing the wearer of the control apparatus 100 (the conversation partner of the wearer of the control apparatus 100) while referring to the CG content displayed on the internal display 101. The display control processing shown in FIG. 3 is realized by the CPU 109 executing a program loaded from the nonvolatile memory 111 to the memory 110. The display control processing shown in FIG. 3 is started, for example, when the control apparatus 100 receives an instruction to start the display control processing from the wearer of the control apparatus 100, or when the external image pickup unit 107 detects a person around the wearer of the control apparatus 100.

As shown in FIG. 3, first, in S301, based on the direction of the sight line of the wearer of the control apparatus 100, which has been detected by the sight line detecting unit 105, the CPU 109 determines whether or not the sight line of the wearer of the control apparatus 100 is facing the CG content displayed on the internal display 101.

In the case of being determined in S301 that the sight line of the wearer of the control apparatus 100 is facing the CG content displayed on the internal display 101, the display control processing shown in FIG. 3 proceeds to S302. In S302, the CPU 109 causes the external display 106 to display an image that imitates the eyes looking in the direction of the conversation partner of the wearer of the control apparatus 100. Specifically, the CPU 109 applies the image processing to an image of eyes of the wearer of the control apparatus 100, which has been obtained (captured) by the internal image pickup unit 104, by using the image processing unit 112, thereby generating an image that imitates the eyes looking in the direction of the conversation partner of the wearer of the control apparatus 100. The CPU 109 causes the external display 106 to display the image imitating the eyes looking in the direction of the conversation partner of the wearer of the control apparatus 100, which has been generated. If there are a plurality of persons around the wearer who is able to have a conversation with the plurality of persons, the external display 106 may be caused to display an image imitating the eyes looking in a direction of a person that the wearer has been looking at immediately before, or an image imitating the eyes looking in a direction of a person whose face has been registered in advance. It should be noted that the processing method for generating an image to be displayed in S302 is not particularly limited. For example, images of the wearer in various sight line directions may be obtained (captured) in advance by the internal image pickup unit 104, and the images of the wearer in the various sight line directions that have been obtained may be constructed as a 3D avatar model, which may then be generated in real time in accordance with the direction of the sight line detected by the sight line detecting unit 105. In addition, the image to be displayed in S302 may be an image of eyes that look similar to actual eyes, or may be an image of eyes that are more abstract than actual eyes, for example, an anime-style image. Next, the display control processing shown in FIG. 3 proceeds to S304, which will be described below.

In the case of being determined in S301 that the sight line of the wearer of the control apparatus 100 is not facing the CG content displayed on the internal display 101, the display control processing shown in FIG. 3 proceeds to S303. In S303, the CPU 109 causes the external display 106 to display the image of the eyes of the wearer of the control apparatus 100, which has been obtained (captured) by the internal image pickup unit 104.

Next, in S304, the CPU 109 determines whether or not the conversation is finished. It should be noted that the determination in S304 may be made based on whether or not the wearer of the control apparatus 100 has issued an instruction to end the display control processing. In addition, the determination in S304 may be made based on whether or not there is a person with whom the wearer is able to have a conversation around the wearer, by using an image obtained (captured) by the external image pickup unit 107. In addition, the determination in S304 may be made by combining other methods.

In the case of being determined in S304 that the conversation is not finished, the display control processing shown in FIG. 3 returns to S301. On the other hand, in the case of being determined in S304 that the conversation is finished, the display control processing shown in FIG. 3 ends.

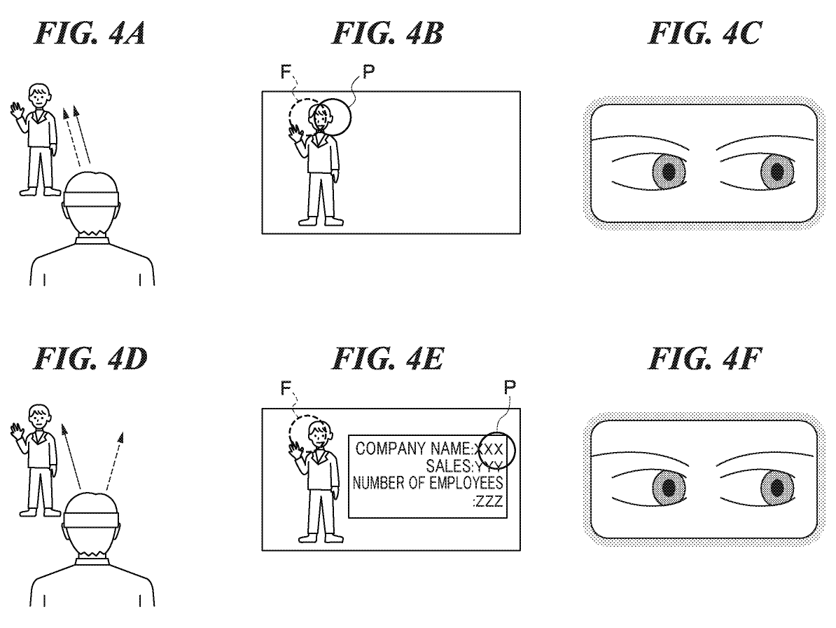

Hereinafter, a specific example of image display by the display control processing shown in FIG. 3, which has been described above, will be described with reference to FIG. 4A, FIG. 4B, FIG. 4C, FIG. 4D, FIG. 4E, and FIG. 4F. Here, like FIG. 2A described above, FIG. 4A is a diagram that illustrates a situation in which the wearer (on this side) of the control apparatus 100 is having a conversation with a non-wearer (on the back side). In FIG. 4A, a dotted-line arrow indicates a sight line direction of the wearer of the control apparatus 100, and a solid-line arrow indicates a sight line direction of eyes displayed on the external display 106, both of which are facing a direction of the conversation partner (the non-wearer). FIG. 4B is a diagram that illustrates an example of the display content of the internal display 101 in the situation shown in FIG. 4A. On the internal display 101, a surrounding image obtained (captured) by the external image pickup unit 107 is displayed in pass-through, and this surrounding image includes the conversation partner of the wearer of the control apparatus 100. In addition, although P and F are not displayed on the internal display 101, P and F respectively represent a gaze point P of the wearer of the control apparatus 100, which has been detected by the sight line detecting unit 105, and a person position F that has been detected by the image processing unit 112. In this situation, since the position of the gaze point P does not match the position of the CG content (explanatory materials), the CPU 109 determines in S301 that the sight line of the wearer of the control apparatus 100 is not facing the CG content displayed on the internal display 101, and then the display control processing shown in FIG. 3 proceeds to S303. In S303, as shown in FIG. 4C, the image of the eyes of the wearer of the control apparatus 100, which has been obtained (captured) by the internal image pickup unit 104, is displayed on the external display 106. This image is, as shown in FIG. 4A, an image of the eyes of the wearer of the control apparatus 100, which has been photographed by the internal image pickup unit 104. A sight line direction of this image becomes the direction indicated by the solid-line arrow shown in FIG. 4A, which is the same as the sight line direction of the wearer of the control apparatus 100 (the direction indicated by the dotted-line arrow shown in FIG. 4A).

On the other hand, FIG. 4D is a diagram that illustrates a situation in which the wearer (on this side) of the control apparatus 100 is having a conversation with the non-wearer (on the back side) while looking at the CG content (the explanatory materials) displayed on the right side of the internal display 101. FIG. 4E is a diagram that illustrates an example of the display content of the internal display 101 in the situation shown in FIG. 4D. In this situation, since the position of the gaze point P matches the position of the CG content (the explanatory materials), the CPU 109 determines in S301 that the sight line of the wearer of the control apparatus 100 is facing the CG content displayed on the internal display 101, and then the display control processing shown in FIG. 3 proceeds to S302. In S302, as shown in FIG. 4F, the image, which imitates the eyes looking in the direction of the conversation partner of the wearer of the control apparatus 100, is displayed on the external display 106. A sight line direction of this image becomes a direction indicated by a solid-line arrow shown in FIG. 4D (that is, the direction of the conversation partner of the wearer of the control apparatus 100), which is different from an actual sight line direction of the wearer of the control apparatus 100 who is looking at the CG content (a direction indicated by a dotted-line arrow shown in FIG. 4D).

According to the above-described embodiment, in the case where the sight line of the wearer of the control apparatus 100 is facing the CG content displayed on the internal display 101, the image, which imitates the eyes looking in the direction of the conversation partner of the wearer of the control apparatus 100, is displayed on the external display 106. This enables a person who is having a face-to-face conversation with the wearer of the control apparatus 100 to naturally feel the sight line of the wearer of the control apparatus 100.

In addition, in the above-described embodiment, in the case where the sight line of the wearer of the control apparatus 100 is not facing the CG content displayed on the internal display 101, the image of the eyes of the wearer of the control apparatus 100, which has been obtained (captured) by the internal image pickup unit 104, is displayed on the external display 106. As a result, the conversation partner of the wearer of the control apparatus 100 is able to know that the wearer of the control apparatus 100 is looking at him/her, allowing for smooth communication.

In the above-described embodiment, in the case where a person is detected around the wearer of the control apparatus 100 by the external image pickup unit 107 and the sight line of the wearer of the control apparatus 100 is facing the CG content displayed on the internal display 101, the image, which imitates the eyes looking in the direction of the conversation partner of the wearer of the control apparatus 100, is displayed on the external display 106. As a result, only in a situation where there is a possibility that the wearer of the control apparatus 100 will be having a face-to-face conversation, it is possible to execute the control that displays the image imitating the eyes, which has been described above.

In the above-described embodiment, in the case where a plurality of persons are detected around the wearer of the control apparatus 100 by the external image pickup unit 107 and the sight line of the wearer of the control apparatus 100 is facing the CG content displayed on the internal display 101, the image, which imitates the eyes looking in the direction of the person that the wearer has been looking at immediately before among the plurality of persons, is displayed on the external display 106. Here, among the plurality of persons that have been detected by the external image pickup unit 107, the person that the wearer of the control apparatus 100 has been looking at immediately before is highly likely to be the conversation partner of the wearer of the control apparatus 100, and it is desirable to perform the control so that the wearer of the control apparatus 100 is able to communicate smoothly with the person that the wearer of the control apparatus 100 has been looking at immediately before. By performing the control as described above, in the case where the wearer of the control apparatus 100 has a conversation with the person that the wearer of the control apparatus 100 has been looking at immediately before, it is possible for the person that the wearer of the control apparatus 100 has been looking at immediately before to naturally feel the sight line of the wearer of the control apparatus 100.

In the above-described embodiment, in the case where a plurality of persons are detected around the wearer of the control apparatus 100 by the external image pickup unit 107 and the sight line of the wearer of the control apparatus 100 is facing the CG content displayed on the internal display 101, the image, which imitates the eyes looking in the direction of the person whose face has been registered in advance among the plurality of persons, is displayed on the external display 106. Here, the wearer of the control apparatus 100 is highly likely to have a conversation with the person whose face has been registered in advance among the plurality of persons that have been detected by the external image pickup unit 107, and it is desirable to perform the control so that the wearer of the control apparatus 100 is able to communicate smoothly with the person whose face has been registered in advance. By performing the control as described above, in the case where the wearer of the control apparatus 100 has a conversation with the person whose face has been registered in advance, it is possible for the person whose face has been registered in advance to naturally feel the sight line of the wearer of the control apparatus 100.

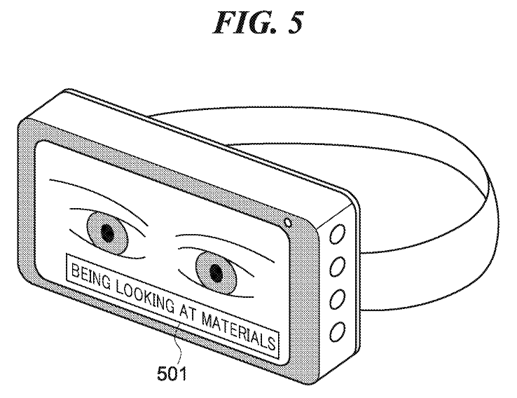

It should be noted that in the present embodiment, the control apparatus 100 may be provided with a function of displaying on the external display 106 that the CG content is being viewed. For example, in the case of being determined in S301 that the sight line of the wearer of the control apparatus 100 is facing the CG content displayed on the internal display 101, in S302, the control apparatus 100, which is provided with such a function, causes the external display 106 to display a message 501 shown in FIG. 5, which indicates that the CG content is being viewed, together with an image that imitates the eyes looking in the direction of the conversation partner of the wearer of the control apparatus 100. It should be noted that although FIG. 5 shows a display example of the message 501, which indicates that the materials are being viewed, the display content is not limited to this display example. For example, any combination of symbols, character strings, and images may be used as the display content. By performing the control in this manner, it is possible to convey, to the conversation partner of the wearer of the control apparatus 100, that the wearer of the control apparatus 100 is actually looking at the CG content (the explanatory materials).

In addition, in the present embodiment, the display content of the external display 106 may be switched depending on the type of the CG content that the wearer of the control apparatus 100 is gazing at.

For example, in the case where a customer trying out a virtual product in a retail store (the wearer of the control apparatus 100) is having a conversation with a shop clerk (the non-wearer), information such as which product the customer is looking at is important to the shop clerk. Therefore, in the present embodiment, the display content of the external display 106 is decided based on the type of the CG content that the wearer of the control apparatus 100 is gazing at. For example, in the case where the CG content that the wearer of the control apparatus 100 (the customer) is gazing at is a piece of virtual furniture, the external display 106 displays an image of the piece of virtual furniture that the wearer of the control apparatus 100 (the customer) is gazing at, instead of displaying an image that imitates eyes looking in a direction of the shop clerk. By displaying the image of the piece of virtual furniture that the wearer of the control apparatus 100 (the customer) is gazing at, the shop clerk is able to know which piece of furniture the customer is interested in.

In addition, in the case where the CG content that the wearer of the control apparatus 100 (the customer) is gazing at is a virtual car, the external display 106 displays an image of the part of the virtual car that the wearer of the control apparatus 100 (the customer) is gazing at, such as a steering wheel or an instrument panel, instead of displaying the image that imitates the eyes looking in the direction of the shop clerk. By displaying the image of the part of the virtual car that the wearer of the control apparatus 100 (the customer) is gazing at, such as the steering wheel or the instrument panel, the shop clerk is able to know which part of the virtual car the customer is interested in. It should be noted that here, although a piece of virtual furniture and a virtual car have been described as examples of the CG content, the CG content is not limited to a piece of virtual furniture or a virtual car, and may be another content such as an avatar or a building.

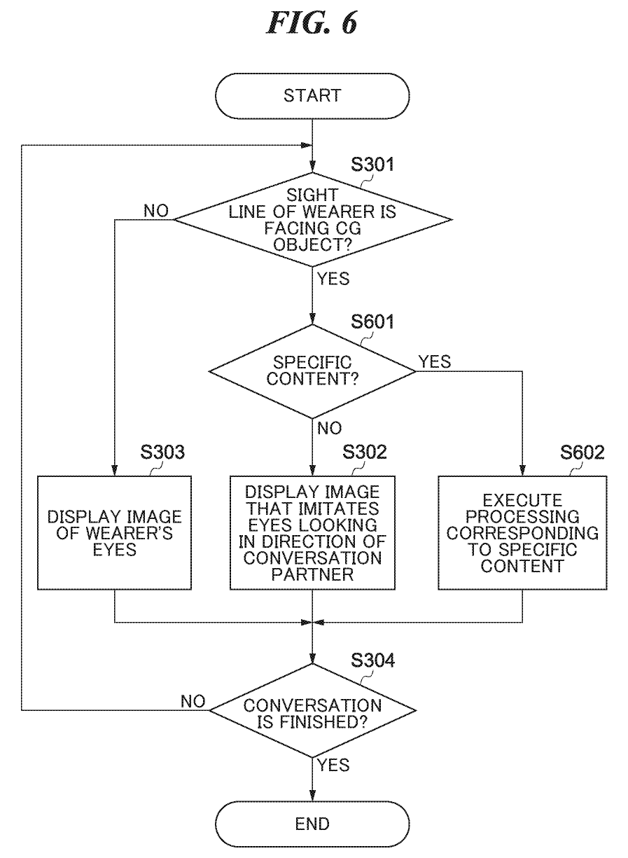

Next, the operation for realizing the above control will be described with reference to FIG. 6.

FIG. 6 is a flowchart that illustrates another procedure of the display control processing executed by the control apparatus 100 shown in FIG. 1A, FIG. 1B, and FIG. 1C. It should be noted that the display control processing shown in FIG. 6 is a processing similar to the display control processing shown in FIG. 3 that has been described above, and the following will particularly describe the differences from the display control processing shown in FIG. 3 that has been described above. Similar to the display control processing shown in FIG. 3 that has been described above, the display control processing shown in FIG. 6 is also realized by the CPU 109 executing a program loaded from the nonvolatile memory 111 to the memory 110. Similar to the display control processing shown in FIG. 3 that has been described above, the display control processing shown in FIG. 6 is also started, for example, when the control apparatus 100 receives an instruction to start the display control processing from the wearer of the control apparatus 100, or when the external image pickup unit 107 detects a person around the wearer of the control apparatus 100.

As shown in FIG. 6, first, S301 that has been described above is performed. In the case of being determined in S301 that the sight line of the wearer of the control apparatus 100 is not facing the CG content displayed on the internal display 101, the display control processing shown in FIG. 6 proceeds to S303, and then S304 is performed in the same manner as the display control processing shown in FIG. 3 that has been described above, and then the display control processing shown in FIG. 6 ends.

In the case of being determined in S301 that the sight line of the wearer of the control apparatus 100 is facing the CG content displayed on the internal display 101, the display control processing shown in FIG. 6 proceeds to S601. In S601, the CPU 109 determines whether or not the CG content in front of the sight line of the wearer of the control apparatus 100, which has been detected by the sight line detecting unit 105, is a specific content that has been set in advance. The specific content is, for example, a commercial virtual content. Examples of the commercial virtual content include a piece of virtual furniture, an avatar, a building, and a virtual car.

In the case of being determined in S601 that the CG content in front of the sight line of the wearer of the control apparatus 100 is a specific content, the display control processing shown in FIG. 6 proceeds to S602. In S602, the CPU 109 executes a processing that has been set in advance in association with the specific content. For example, in the case where the CG content in front of the sight line of the wearer of the control apparatus 100 is a piece of virtual furniture, the CPU 109 causes the external display 106 to display an image of the piece of virtual furniture that the wearer of the control apparatus 100 is gazing at. In addition, in the case where the CG content in front of the sight line of the wearer of the control apparatus 100 is a virtual car, the CPU 109 causes the external display 106 to display an image of the part of the virtual car that the wearer of the control apparatus 100 is gazing at, such as a steering wheel or an instrument panel. Next, the display control processing shown in FIG. 6 proceeds to S304 that has been described above, and then the display control processing shown in FIG. 6 ends.

In the case of being determined in S601 that the CG content in front of the sight line of the wearer of the control apparatus 100 is not a specific content, the display control processing shown in FIG. 6 proceeds to S302 that has been described above. As a result, for example, in the case where the customer who is the wearer of the control apparatus 100 is having a conversation with the shop clerk while looking at a CG content other than the specific content, such as explanatory materials, an image that imitates the eyes looking in the direction of the shop clerk is displayed on the external display 106. Next, the display control processing shown in FIG. 6 proceeds to S304 that has been described above, and then the display control processing shown in FIG. 6 ends.

It should be noted that in the present embodiment, the case where the control apparatus 100 is a head mounted display device has been described, but the control apparatus 100 is not limited to a head mounted display device. For example, the control apparatus 100 may be an apparatus that is separate from a head mounted display device such as an HMD and that performs the display control of the head mounted display device. Even with such a configuration, it is possible to achieve the same effects as those of the above-described embodiment.

According to the present disclosure, it is possible for a person who is having a face-to-face conversation with an HMD wearer to naturally feel a sight line of the HMD wearer.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-043627, filed March 18, 2025, which is hereby incorporated by reference herein in its entirety.

What is claimed is:

1. A control apparatus for controlling a display of a head mounted display device, the control apparatus comprising one or more processors and memory configured to:
execute a first detection processing that, based on an image obtained by a first photographing unit provided in the head mounted display device to be oriented to photograph a sight line direction of a wearer of the head mounted display device, detects a person around the wearer;
execute a second detection processing that, based on an image obtained by a second photographing unit provided in the head mounted display device to be oriented to photograph the wearer side, detects a direction of a sight line of the wearer; and
execute a control processing that causes an outer display of the head mounted display device to display an image of eyes of the wearer, which has been obtained by the second photographing unit, and
wherein, in the control processing, in a case where the sight line of the wearer is facing a CG content displayed on an inner display of the head mounted display device, the outer display is caused to display an image imitating eyes looking in a direction of the person detected by the first detection processing.

2. The control apparatus according to claim 1, wherein
in the control processing, in a case where the sight line of the wearer is not facing the CG content displayed on the inner display, the outer display is caused to display the image of the eyes of the wearer, which has been obtained by the second photographing unit.

3. The control apparatus according to claim 1, wherein
in the control processing, in the case where the sight line of the wearer is facing the CG content displayed on the inner display, the outer display is caused to display information indicating that the wearer is looking at the CG content, together with the image imitating the eyes looking in the direction of the person detected by the first detection processing.

4. The control apparatus according to claim 1, wherein
in the control processing, in the case where the sight line of the wearer is facing the CG content displayed on the inner display, display content to be displayed on the outer display is switched based on whether or not the CG content is a specific content that has been set in advance.

5. The control apparatus according to claim 4, wherein
the specific content is a commercial virtual content.

6. The control apparatus according to claim 1, wherein
in the control processing, in a case where a person is detected around the wearer by the first detection processing and the sight line of the wearer is facing the CG content displayed on the inner display, the outer display is caused to display an image imitating eyes looking in a direction of the person detected by the first detection processing.

7. The control apparatus according to claim 1, wherein
in the control processing, in a case where a plurality of persons are detected around the wearer by the first detection processing and the sight line of the wearer is facing the CG content displayed on the inner display, the outer display is caused to display an image, which imitates eyes looking in a direction of a person that the wearer has been looking at immediately before among the plurality of persons.

8. The control apparatus according to claim 1, wherein
in the control processing, in a case where a plurality of persons are detected around the wearer by the first detection processing and the sight line of the wearer is facing the CG content displayed on the inner display, the outer display is caused to display an image, which imitates eyes looking in a direction of a person whose face has been registered in advance among the plurality of persons.

9. The control apparatus according to claim 1, wherein
the control apparatus is the head mounted display device.

10. The control apparatus according to claim 1, wherein
the control apparatus is an apparatus separate from the head mounted display device.

11. A control method for a control apparatus for controlling a display of a head mounted display device, the control method comprising:
a first detection step of, based on an image obtained by a first photographing unit provided in the head mounted display device to be oriented to photograph a sight line direction of a wearer of the head mounted display device, detecting a person around the wearer;
a second detection step of, based on an image obtained by a second photographing unit provided in the head mounted display device to be oriented to photograph the wearer side, detecting a direction of a sight line of the wearer; and
a control step of causing an outer display of the head mounted display device to display an image of eyes of the wearer, which has been obtained by the second photographing unit, and
wherein, in the control step, in a case where the sight line of the wearer is facing a CG content displayed on an inner display of the head mounted display device, an image, which imitates eyes looking in a direction of the person detected in the first detection step, is displayed on the outer display.

12. A non-transitory computer-readable storage medium storing a program for causing a computer to execute a control method for a control apparatus for controlling a display of a head mounted display device, the control method comprising:
a first detection step of, based on an image obtained by a first photographing unit provided in the head mounted display device to be oriented to photograph a sight line direction of a wearer of the head mounted display device, detecting a person around the wearer;
a second detection step of, based on an image obtained by a second photographing unit provided in the head mounted display device to be oriented to photograph the wearer side, detecting a direction of a sight line of the wearer; and
a control step of causing an outer display of the head mounted display device to display an image of eyes of the wearer, which has been obtained by the second photographing unit, and
wherein, in the control step, in a case where the sight line of the wearer is facing a CG content displayed on an inner display of the head mounted display device, an image, which imitates eyes looking in a direction of the person detected in the first detection step, is displayed on the outer display.
